(19) United States
(12) Patent Application Publication
(10) Pub. No.: US 2026/0310957 A1
(43) Pub. Date: Oct. 8, 2026

(54) TRAINING PHYSICS-INFORMED NEURAL NETWORK SURROGATE MODELS TO MODEL PHYSICAL PROBLEMS USING THE FINITE ELEMENT METHOD

(71) Applicant: Rutgers, The State University of New Jersey, New Brunswick, NJ (US)

(72) Inventor: Ryan B. Sills, Skillman, NJ (US)

(73) Assignee: Rutgers, The State University of New Jersey, New Brunswick, NJ (US)

(21) Appl. No.: 19/479,457

(22) PCT Filed: May 3, 2024
(86) PCT No.: PCT/US2024/027843

§ 371 Date: Oct. 28, 2025

Related U.S. Application Data
(60) Provisional application No. 63/500,438, filed on May 5, 2023.

(51) Int. Cl. G06N 3/08; G06F 30/23; G06N 3/0464

(52) U.S. Cl. CPC G06N 3/08; G06F 30/23; G06N 3/0464

(57) ABSTRACT

Systems and methods for training physics-informed neural network (PINN) surrogate models to model physical problems are provided. The method may comprise coupling, using a processor, one or more convolutional neural networks (CNNs) with a finite element method (FEM). The coupling may comprise calculating, for a finite element mesh comprising a plurality of finite elements, an internal force vector, P, and a force vector, F, using the FEM. Each finite element may comprise one or more finite element nodes. The coupling may further comprise applying a CNN to the finite element mesh to obtain a solution to a physical problem. The CNN may be trained on a loss function, and the loss function may incorporate the internal force vector, P, and the force vector, F.

### CROSS-REFERENCE TO RELATED APPLICATIONS

This application claims priority under 35 U.S.C. § 119(e) to U.S. Provisional Patent Application No. 63/500,438, filed May 5, 2023. The foregoing application is incorporated by reference herein in its entirety.

### STATEMENT REGARDING FEDERALLY SPONSORED RESEARCH

This invention was made with government support under grant number 2237039 awarded by the National Science Foundation. The government has certain rights in the invention.

### FIELD

Embodiments of the present disclosure relate to systems and methods for training physics-informed neural network (PINN) surrogate models to model physical problems.

### BACKGROUND

Workhorse convolution operators used in convolutional neural networks assume a uniform, pixelated grid (e.g., an image). Such a grid provides a poor representation of irregular domains, leading to non-conformal representations at the boundaries. Finite element meshes, however, are conformal to boundaries, but elements have irregular shapes.

### SUMMARY

According to an object of the present disclosure, a method for training physics-informed neural network (PINN) surrogate models to model physical problems is provided. The method may comprise coupling, using a processor, one or more convolutional neural networks (CNNs) with the finite element method (FEM). The coupling may comprise calculating, for a finite element mesh comprising a plurality of finite elements, an internal force vector, P, and a force vector, F, using the FEM. Each finite element may comprise one or more finite element nodes. The coupling may further comprise applying a CNN to the finite element mesh to obtain a solution to a physical problem. The CNN may be trained on a loss function, and the loss function may incorporate the internal force vector, P, and the force vector, F.

According to various embodiments, the plurality of finite elements may represent a spatiotemporal variation of one or more physical quantities into which the physical problem can be divided.

According to various embodiments, the one or more physical quantities may comprise one or more of the following: one or more quantities pertaining to solid mechanics, fluid mechanics, electromagnetic radiation, and heat transfer.

According to various embodiments, the loss function may comprise:

$$ℒ ( d ) = ‖ P ( d ) - F ‖$$

where d denotes a solution vector of the physical problem.

According to various embodiments, d may denote a nodal solution vector.

According to various embodiments, when the physical problem comprises a linear physical problem, the internal force vector, P, may be computed as P(d)=Kd, where K is a stiffness matrix.

According to various embodiments, when the physical problem comprises a non-linear physical problem, the applying the CNN to each finite element node may comprise iteratively applying a CNN for each of a plurality of solution vectors, d.

According to various embodiments, the applying the CNN may comprise applying a convolutional operator, using a stencil tensor, S_{m,n}, to perform one or more convolutions. The stencil tensor S_{m,n} may comprise an N×N grid and one or more convolutions of the CNN are enabled by placing the stencil tensor overtop of a finite element node, of one or more finite element nodes, and then evaluating a field at each of one or more stencil points using an inverse isoparametric map.

According to various embodiments, the convolution operator may have the form:

$${O}_{i} = {\sum }_{m = - α}^{α} {\sum }_{n = - α}^{α} I ( {x}_{i} + {S}_{m , n} , {P}_{m , n} ) {W}_{m , n}$$

where:
Oᵢ is an output of a convolution for node i,
xᵢ is a position vector of node i,
W_{m,n} is a weight tensor for the convolution for node i,
P_{m,n} is an additional parameter tensor used in convolution for node i,
I(x) is an evaluation of the input field at position x, and

$$α = ( N - 1 ) / 2 .$$

According to various embodiments, the calculating, for each finite element, the internal force vector, P, and the force vector, F, using the FEM, may comprise training a surrogate model to a plurality of finite elements of the one or more finite elements.

According to various embodiments, the calculating, for the finite element mesh, the internal force vector, P, and the force vector, F, using the FEM, may comprise constructing a training case, and each training case may correspond to one or more ingredients necessary to establish a finite element problem.

According to various embodiments, the one or more ingredients may comprise one or more of the following: a finite element mesh of a chosen geometry; one or more constitutive models to describe one or more substance behaviors in the one or more constitutive models; a set of boundary conditions; a set of source terms; and a set of body forces.

According to an object of the present disclosure, a system for training PINN surrogate models to model physical problems is provided. The system may comprise a computing device, comprising a processor and a memory configured to store programming instructions. The programming instructions, when executed by the processor, may be configured to cause the processor to couple one or more CNNs with the FEM. The coupling may comprise calculating, for a finite element mesh comprising a plurality of finite elements, an internal force vector, P, and a force vector, F, using the FEM. Each finite element may comprise one or more finite element nodes. The coupling may further comprise applying a CNN to the finite element mesh, to obtain a solution to a physical problem. The CNN may be trained on a loss function, and the loss function may incorporate the internal force vector, P, and the force vector, F.

According to various embodiments, the plurality of finite elements may represent a spatiotemporal variation of one or more physical quantities into which the physical problem can be divided.

According to various embodiments, the one or more physical quantities may comprise one or more of the following: one or more quantities pertaining to solid mechanics, fluid mechanics, electromagnetic radiation, and heat transfer.

According to various embodiments the loss function comprises:

$$ℒ ( d ) = ‖ P ( d ) - F ‖$$

where d denotes a solution vector of the physical problem.

According to various embodiments, d may denote a nodal solution vector.

According to various embodiments, when the physical problem comprises a linear physical problem, the internal force vector, P, may be computed as P(d)=Kd, where K is a stiffness matrix.

According to various embodiments, when the physical problem comprises a non-linear physical problem, the applying the CNN to a finite element node may comprise iteratively applying a CNN for each of a plurality of solution vectors, d.

According to various embodiments, the applying the CNN may comprise applying a convolutional operator, using a stencil tensor, S_{m,n}, to perform one or more convolutions. The stencil tensor S_{m,n} may comprise an N×N grid, and one or more convolutions of the CNN may be enabled by placing the stencil tensor over top of a finite element node, of one or more finite element nodes, and then evaluating a field at each of one or more stencil points using an inverse isoparametric map.

According to various embodiments, the convolution operator may have the form:

$${O}_{i} = {\sum }_{m = - α}^{α} {\sum }_{n = - α}^{α} I ( {x}_{i} + {S}_{m , n} , {P}_{m , n} ) {W}_{m , n}$$

where:
Oᵢ is an output of a convolution for node i,
xᵢ is a position vector of node i,
W_{m,n} is a weight tensor for the convolution for node i,
P_{m,n} is an additional parameter tensor used in convolution for node i,
I(x) is an evaluation of the input field at position x, and

$$α = ( N - 1 ) / 2 .$$

According to various embodiments, the calculating, for the finite element mesh, the internal force vector, P, and the force vector, F, using the FEM, may comprise training a surrogate model to one or more finite elements, of the one or more finite elements.

According to various embodiments, the calculating, for the finite element mesh, the internal force vector, P, and the force vector, F, using the FEM, may comprise constructing a training case, and each training case may correspond to one or more ingredients necessary to establish a finite element problem.

According to various embodiments, the one or more ingredients may comprise one or more of the following: a finite element mesh of a chosen geometry, one or more constitutive models to describe one or more substance behaviors in the one or more constitutive models, a set of boundary conditions, a set of source terms, and a set of body forces.

### BRIEF DESCRIPTION OF THE DRAWINGS

FIG. 1 is an example flowchart of a method for training physics-informed neural network (PINN) surrogate models to model physical problems, according to various embodiments of the present disclosure.

FIG. 2 illustrates a stencil tensor applied to a finite element mesh at node k, according to various embodiments of the present disclosure.

FIGS. 3A-3C show example results for a simulation for a range of wedge angles, illustrating loss convergence during training (FIG. 3A), solution fields from FEM and a trained finite element PINN (FE-PINN) (FIG. 3B), and an FE-PINN error as a function of wedge angle after training with angles 0° and 50° (FIG. 3C), according to various embodiments of the present disclosure.

FIG. 4 illustrates example elements of a computing device, according to various embodiments of the present disclosure.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

The terms “memory,” “memory device,” “computer-readable storage medium,” “data store,” “data storage facility” and the like each refer to a non-transitory device on which computer-readable data, programming instructions or both are stored. Except where specifically stated otherwise, the terms “memory,” “memory device,” “computer-readable storage medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “module” refers to a set of computer-readable programming instructions, as executed by a processor, that cause the processor to perform a specified function.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable programming instructions executed by a processor, controller, or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network-coupled computer systems so that the computer readable media may be stored and executed in a distributed fashion, such as, e.g., by a telematics server or a Controller Area Network (CAN).

Unless specifically stated or obvious from context, as used herein, the term “about” is understood as within a range of normal tolerance in the art, for example, within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

Hereinafter, some embodiments of the present disclosure will be described in detail with reference to the drawings. In the drawings, the same reference numerals will be used throughout to designate the same or equivalent elements. In addition, a detailed description of well-known features or functions will be ruled out in order not to unnecessarily obscure the gist of the present disclosure.

Hereinafter, systems and methods for training physics-informed neural network (PINN) surrogate models to model physical problems, according to embodiments of the present disclosure, will be described with reference to the accompanying drawings.

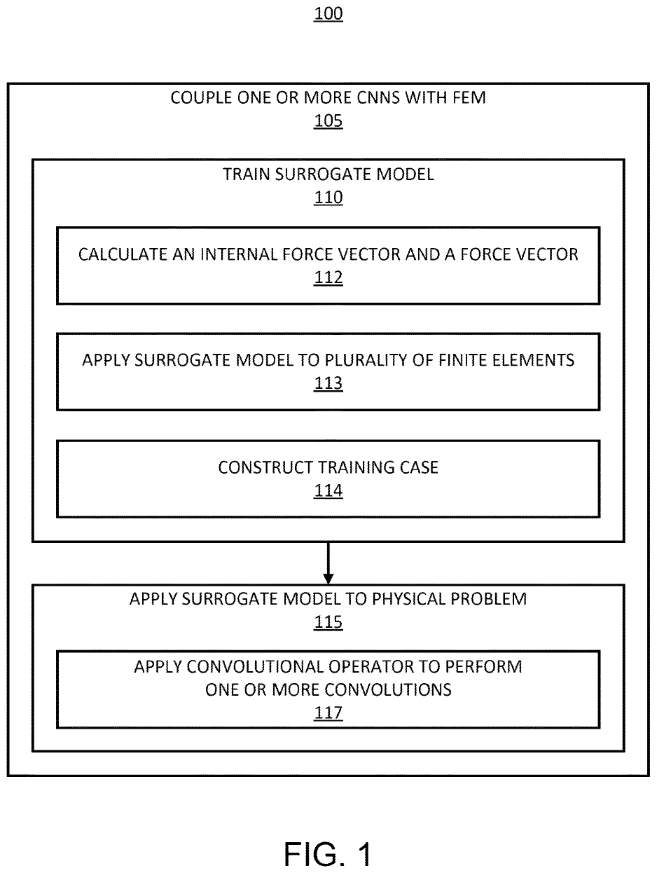

Referring now to FIG. 1, an example method 100 for training physics-informed neural network (PINN) surrogate models to model physical problems is illustratively depicted, in accordance with various embodiments of the present disclosure.

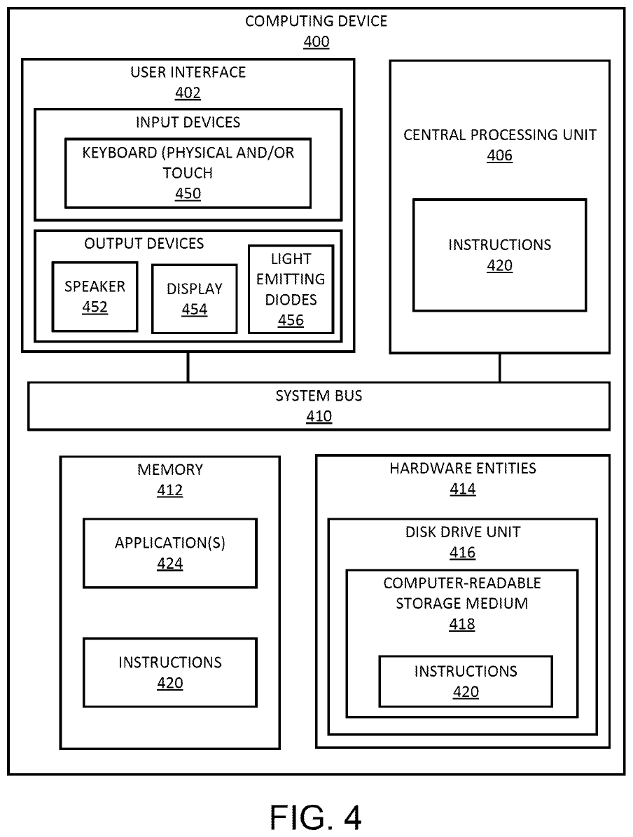

At 105, one or more convolutional neural networks (CNNs) may be coupled with a finite element method (FEM). According to various embodiments, the coupling may be performed using a computing device (e.g., computing device 400 as shown in FIG. 4). According to various embodiments, the coupling may comprise, at 110, training a surrogate model. According to various embodiments, training the surrogate model may comprise, at 112, calculating, for a finite element mesh comprising a plurality of finite elements, an internal force vector, P, and a force vector, F, using the FEM. Each finite element may comprise one or more finite element nodes.

According to various embodiments, the plurality of finite elements may represent a spatiotemporal variation of one or more physical quantities into which the physical problem can be divided. According to various embodiments, the one or more physical quantities may comprise one or more of the following: one or more quantities pertaining to solid mechanics, fluid mechanics, electromagnetic radiation, and heat transfer. According to various embodiments, d may denote a nodal solution vector. According to various embodiments, d may be a nodal solution vector for whatever field is of interest (e.g., temperature, displacement, etc.). This leads to a “physics-informed” neural network since the network is configured to “learn” one or more governing equations rather than “learning” one or more chosen solutions to the equations. This approach may be implemented for industries including, but not limited to, automotive, aviation, aerospace, defense, energy, oil & gas, and structural engineering industries.

The coupling may further comprise, at 115, applying a CNN to a finite element mesh to obtain a solution to a physical problem. According to various embodiments, the CNN may be trained on a loss function, and the loss function may incorporate the internal force vector, P, and the force vector, F. According to various embodiments, the loss function takes the form of Equation 1, where d denotes a solution vector of the physical problem.

$$ℒ ( d ) = ‖ P ( d ) - F ‖ \qquad Equation 1$$

According to various embodiments, the physical problem may comprise a linear physical problem, a non-linear physical problem, and/or a combination of one or more linear physical problems and/or non-linear physical problems. For example, the physical problem may comprise a linear physical problem. According to various embodiments, when the physical problem comprises a linear physical problem, the internal force vector, P, may be computed according to Equation 2.

$$P ( d ) = Kd \qquad Equation 2$$

where K is a stiffness matrix.

According to various embodiments, when the physical problem comprises a non-linear physical problem, the applying the CNN to a finite element node may comprise iteratively applying a CNN for each of a plurality of solution vectors, d.

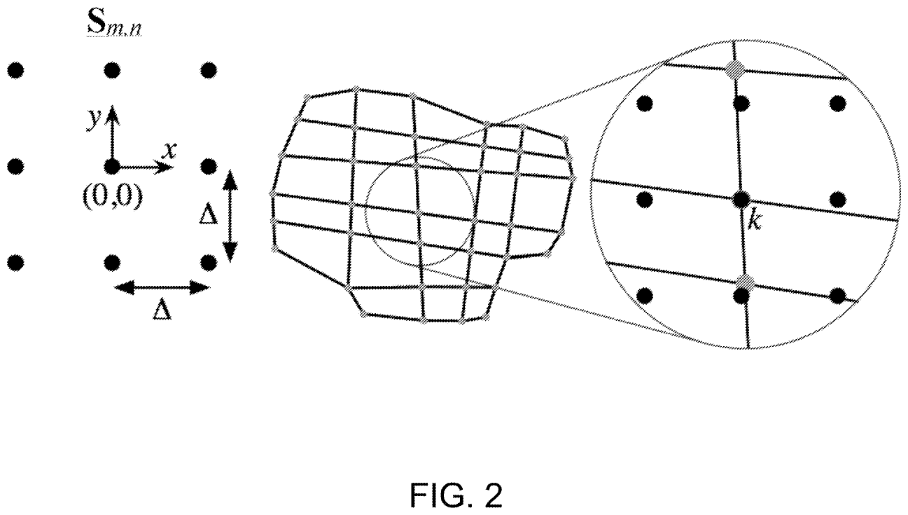

According to various embodiments, the applying the CNN may comprise, at 117, applying a convolutional operator, using a stencil tensor, S_{m,n} (e.g., a non-uniform grid that is yet to be defined) to perform one or more convolutions. The stencil tensor, S_{m,n} may be a regular N×N grid with spacing, Δ, as shown, e.g., in FIG. 2. It is noted, however, that other stencil tensors may be incorporated while maintaining the spirit and functionality of the present disclosure. According to various embodiments, pooling operations, unsampling operations, and/or other suitable operations may be incorporated, in addition to, or instead of, convolution operations, while maintaining the spirit and functionality of the present disclosure.

One or more convolutions of the CNN may be enabled by placing the stencil tensor over top of a finite element node, of one or more finite element nodes, and then a field, at each of one or more stencil points, may be evaluated using an inverse isoparametric map. According to various embodiments, the convolution operator may take the form of Equation 3.

$${O}_{i} = {\sum }_{m = - α}^{α} {\sum }_{n = - α}^{α} I ( {x}_{i} + {S}_{m , n} , {P}_{m , n} ) {W}_{m , n} \qquad Equation 3$$

where Oᵢ is an output of a convolution for node i, xᵢ is a position vector of node i, W_{m,n} is a weight tensor for the convolution for node i, P_{m,n} is an additional parameter tensor used in convolution for node i, I(x) is a evaluation of the input field at position x, and α=(N−1)/2.

According to various embodiments, training the surrogate model may comprise, at 113, applying and/or training a surrogate model to a plurality of finite elements of the one or more finite elements.

According to various embodiments, training the surrogate model may comprise, at 114, constructing a training case. According to various embodiments, each training case may correspond to one or more ingredients necessary to establish a finite element problem. According to various embodiments, the one or more ingredients may comprise a finite element mesh of a chosen geometry; one or more constitutive models to describe one or more substance behaviors in the one or more constitutive models; a set of boundary conditions; a set of source terms; and/or a set of body forces, among other suitable ingredients.

According to various embodiments, predictions for new cases which the finite element PINN (FE-PINN) was not trained on may be evaluated to determine a predictive accuracy of the FE-PINN. According to various embodiments, when performance is not satisfactory (e.g., when prediction errors are too large), then the training set may be augmented and training repeated. According to various embodiments, the FE-PINN code may be configured to load training cases into memory and then may be configured to train the neural network until a training error is satisfactory.

This approach does not require generation of training data, decreasing computing power and memory storage requirements to solve for physical problems, thus improving upon existing technologies. This approach is further configured to efficiently leverage existing computational and modeling infrastructure when training neural-network-based surrogate models. According to various embodiments, using this approach, a major advantage of using FEM to train a PINN is that boundary condition enforcement is automatically established using basic FEM approaches. For essential boundary conditions, the associated nodal degrees of freedom may be removed from the system of equations and replaced by a set of conjugate forces. For natural boundary conditions, additional forces may be included in the force vector. According to various embodiments, no additional approaches need to be developed, and no additional loss terms are necessary, as in the case of weak boundary condition enforcement.

According to various embodiments, this approach may be configured to enable training a PINN which allows for variable geometry and boundary conditions, providing a generalized PINN which, after proper training, can provide a solution for a problem of interest. Problem geometry may be specified by providing all nodal coordinates as input to a network. Similarly, boundary conditions may be specified by inputting nodal values as an input.

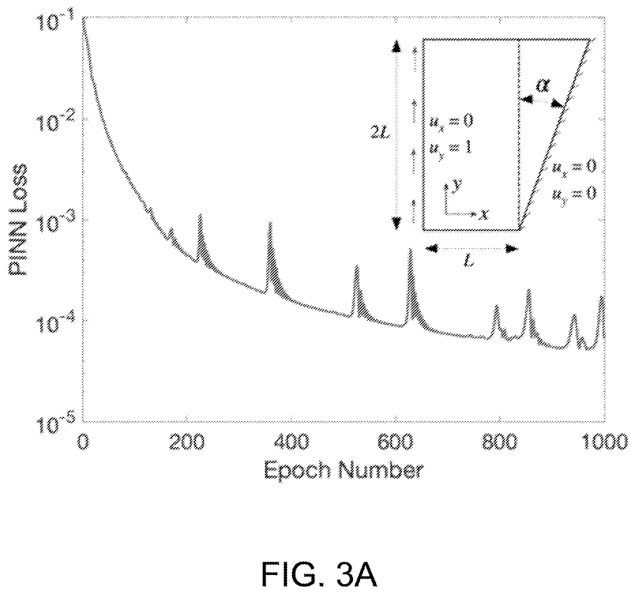

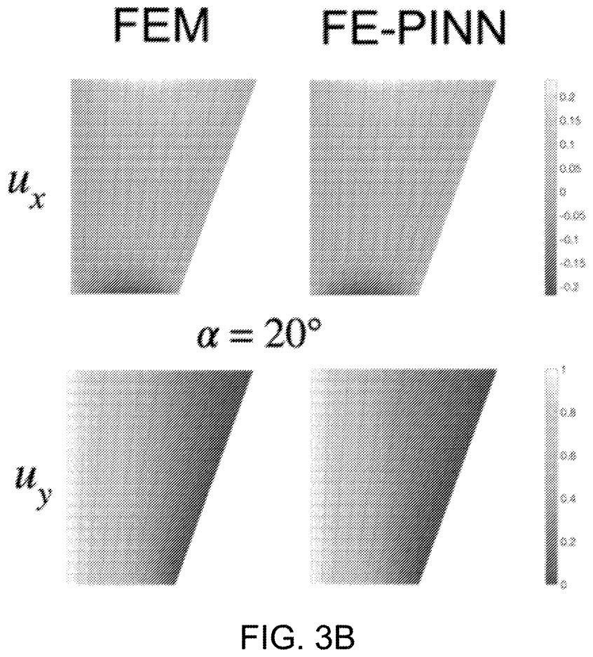

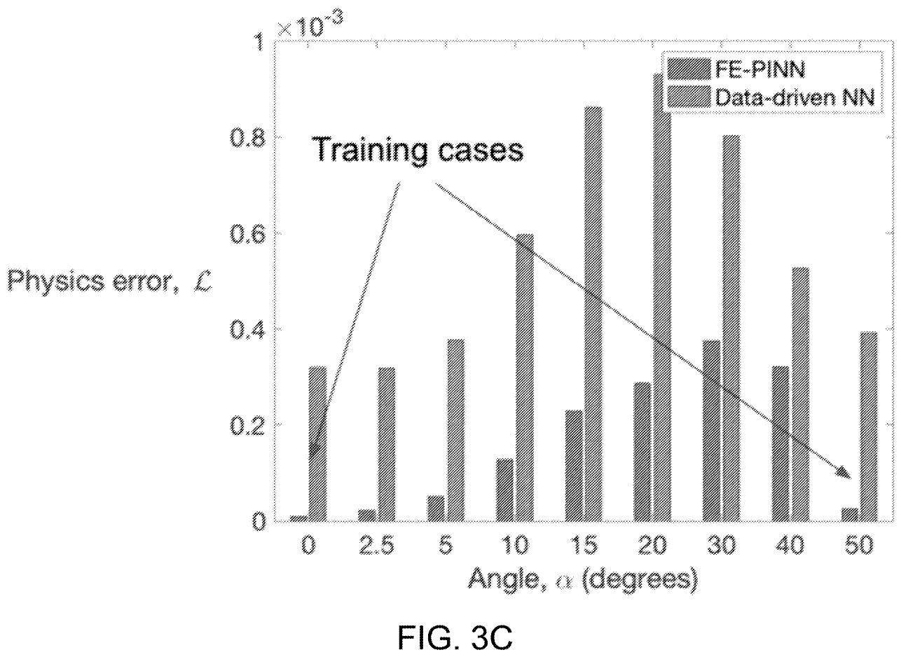

For example, using this approach, loading a wedged block with varying wedge angle loading by a vertical displacement may be simulated. FIGS. 3A-3C show example results for such a simulation for a range of wedge angles, demonstrating that, by training on just two wedge angles (0° and 50°), reasonable predictions may be made for angles in between.

As shown in FIGS. 3A-3C, loss convergence during training (FIG. 3A), solution fields from FEM and a trained FE-PINN (FIG. 3B), and an FE-PINN error as a function of wedge angle after training with angles 0° and 50° (FIG. 3C) are illustratively depicted.

Referring now to FIG. 4, an illustration of an example architecture for a computing device 400 is provided.

The hardware architecture of FIG. 4 represents one example implementation of a representative computing device configured to perform one or more methods and means for training PINN surrogate models to model physical problems, as described herein. As such, the computing device 400 of FIG. 4 implements at least a portion of the method(s) described herein (for example, method 100 of FIG. 1).

Some or all components of the computing device 400 can be implemented as hardware, software and/or a combination of hardware and software. The hardware includes, but is not limited to, one or more electronic circuits. The electronic circuits can comprise, but are not limited to, passive components (e.g., resistors and capacitors) and/or active components (e.g., amplifiers and/or microprocessors). The passive and/or active components may be adapted to, arranged to and/or programmed to perform one or more of the methodologies, procedures, or functions described herein.

As shown in FIG. 4, the computing device 400 may comprise a user interface 402, a Central Processing Unit (“CPU”) 406, a system bus 410, a memory 412 connected to and accessible by other portions of computing device 400 through system bus 410, and hardware entities 414 connected to system bus 410. The user interface may comprise one or more input devices and output devices, which facilitate user-software interactions for controlling operations of the computing device 400. The input devices include, but are not limited to, a physical and/or touch keyboard 450. The input devices can be connected to the computing device 400 via a wired or wireless connection (e.g., a Bluetooth® connection). The output devices may comprise, but are not limited to, a speaker 452, a display 454, and/or light emitting diodes 456.

At least some of the hardware entities 414 may be configured to perform actions involving access to and use of memory 412, which can be a Random Access Memory (RAM), a disk driver and/or a Compact Disc Read Only Memory (CD-ROM), among other suitable memory types. Hardware entities 414 can include a disk drive unit 416 comprising a computer-readable storage medium 418 on which is stored one or more sets of instructions 420 (e.g., programming instructions such as, but not limited to, software code) configured to implement one or more of the methodologies, procedures, or functions described herein. The instructions 420 can also reside, completely or at least partially, within the memory 412 and/or within the CPU 406 during execution thereof by the computing device 400.

The memory 412 and the CPU 406 also can constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 620 for execution by the computing device 400 and that cause the computing device 600 to perform any one or more of the methodologies of the present disclosure. According to various embodiments, one or more computer applications 424 may be stored on the memory 412.

The features and functions described above, as well as alternatives, may be combined into many other different systems or applications. Various alternatives, modifications, variations or improvements may be made by those skilled in the art, each of which is also intended to be encompassed by the disclosed embodiments.

What is claimed is:

1. A method for training physics-informed neural network (PINN) surrogate models to model a physical problem, comprising:
coupling, using a processor, one or more convolutional neural networks (CNNs) with a finite element method (FEM), comprising:
calculating, for a finite element mesh comprising a plurality of finite elements, an internal force vector, P, and a force vector, F, using the FEM, wherein each finite element comprises one or more finite element nodes;
applying a CNN to the finite element mesh to obtain a solution to the physical problem, wherein:
the CNN is trained on a loss function, and
the loss function incorporates the internal force vector, P, and the force vector, F.

2. The method of claim 1, wherein the plurality of finite elements represent a spatiotemporal variation of one or more physical quantities into which the physical problem can be divided.

3. The method of claim 2, wherein the one or more physical quantities comprise one or more of the following:
one or more quantities pertaining to:
solid mechanics;
fluid mechanics;
electromagnetic radiation; and
heat transfer.

4. The method of claim 1, wherein the loss function comprises:
$$ℒ ( d ) = ‖ P ( d ) - F ‖$$
where d denotes a solution vector of the physical problem or wherein d denotes a nodal solution vector.

5. (canceled)

6. The method of claim 4, wherein, (i) when the physical problem comprises a linear physical problem, the internal force vector, P, is computed as P(d)=Kd, where K is a stiffness matrix, or (ii) when the physical problem comprises a non-linear physical problem, the applying the CNN to the finite element mesh comprises iteratively applying a CNN for each of a plurality of solution vectors, d.

7. (canceled)

8. The method of claim 1, wherein the applying the CNN comprises applying a convolutional operator, using a stencil tensor, S_{m,n}, to perform one or more convolutions.

9. The method of claim 8, wherein:
the stencil tensor S_{m,n} is a regular N×N grid with spacing, Δ, and
one or more convolutions of the CNN are enabled by placing the stencil tensor over top of a finite element node, of one or more finite element nodes, and then evaluating a field at each of one or more stencil points using an inverse isoparametric map.

10. The method of claim 9, wherein the convolution operator has the form:
$${O}_{i} = {\sum }_{m = - α}^{α} {\sum }_{n = - α}^{α} I ( {x}_{i} + {S}_{m , n} , {P}_{m , n} ) {W}_{m , n}$$
wherein:
Oᵢ is an output of a convolution for node i,
xᵢ is a position vector of node i,
W_{m,n} is a weight tensor for the convolution for node i,
P_{m,n} is an additional parameter tensor used in convolution for node i,
I(x) is an evaluation of the input field at position x, and
$$α = ( N - 1 ) / 2 .$$

11. The method of claim 1, wherein the calculating, for each finite element, the internal force vector, P, and the force vector, F, using the FEM, comprises:
training a surrogate model to the one or more finite elements.

12. The method of claim 1, wherein:
the calculating, for the finite element mesh, the internal force vector, P, and the force vector, F, using the FEM, comprises constructing a training case, and
each training case corresponds to one or more ingredients necessary to establish a finite element problem.

13. The method of claim 12, wherein the one or more ingredients comprise one or more of the following:
a finite element mesh of a chosen geometry;
one or more constitutive models to describe one or more substance behaviors in the one or more constitutive models;
a set of boundary conditions;
a set of source terms; and
a set of body forces.

14. A system for training physics-informed neural network (PINN) surrogate models to model physical problems, comprising:
a computing device, comprising a processor and a memory configured to store programming instructions, wherein the programming instructions, when executed by the processor, are configured to cause the processor to:
couple one or more convolutional neural networks (CNNs) with a finite element method (FEM), comprising:
calculating, for a finite element mesh comprising a plurality of finite elements, an internal force vector, P, and a force vector, F, using the FEM, wherein each finite element comprises one or more finite element nodes;
applying a CNN to the finite element mesh, to obtain a solution to a physical problem,
wherein:
the CNN is trained on a loss function, and
the loss function incorporates the internal force vector, P, and the force vector, F.

15. The system of claim 14, wherein the plurality of finite elements represent a spatiotemporal variation of one or more physical quantities into which the physical problem can be divided.

16. (canceled)

17. The system of claim 14, wherein the loss function comprises:
$$ℒ ( d ) = ‖ P ( d ) - F ‖$$
wherein d denotes a solution vector of the physical problem, or wherein d denotes a nodal solution vector.

18. (canceled)

19. The system of claim 17, wherein, (i) when the physical problem comprises a linear physical problem, the internal force vector, P, is computed as P(d)=Kd, where K is a stiffness matrix, or (ii) when the physical problem comprises a non-linear physical problem, the applying the CNN to the finite element mesh comprises iteratively applying a CNN for each of a plurality of solution vectors, d.

20. (canceled)

21. The system of claim 14, wherein the applying the CNN comprises applying a convolutional operator, using a stencil tensor, S_{m,n}, to perform one or more convolutions.

22. The system of claim 21, wherein:
the stencil tensor S_{m,n} is a regular N×N grid with spacing Δ, and
one or more convolutions of the CNN are enabled by placing the stencil tensor over top of a finite element node, of one or more finite element nodes, and then evaluating a field at each of one or more stencil points using an inverse isoparametric map.

23. The system of claim 22, wherein the convolution operator has the form:
$${O}_{i} = {\sum }_{m = - α}^{α} {\sum }_{n = - α}^{α} I ( {x}_{i} + {S}_{m , n} , {P}_{m , n} ) {W}_{m , n}$$
wherein:
Oᵢ is an output of a convolution for node i,
xᵢ is a position vector of node i,
W_{m,n} is a weight tensor for the convolution for node i,
P_{m,n} is an additional parameter tensor used in convolution for node i,
I(x) is an evaluation of the input field at position x, and
$$α = ( N - 1 ) / 2 .$$

24. The system of claim 14, wherein the calculating, for the finite element mesh, the internal force vector, P, and the force vector, F, using the FEM, comprises:
training a surrogate model to the one or more finite elements.

25. The system of claim 14, wherein:
the calculating, for the finite element mesh, the internal force vector, P, and the force vector, F, using the FEM, comprises constructing a training case, and
each training case corresponds to one or more ingredients necessary to establish a finite element problem.

26. (canceled)
